(19) United States
(12) Patent Application Publication
(10) Pub. No.: US 2009/0218409 A1
(43) Pub. Date: Sep. 3, 2009

(54) HEATING SYSTEM FOR MOTOR VEHICLE

(76) Inventor: WEN-LO CHEN, Taipei City (TW)

Correspondence Address: LEONG C LEI, PMB # 1008, 1867 YGNACIO VALLEY ROAD, WALNUT CREEK, CA, 94598, US

(21) Appl. No.: 12/039,747

(22) Filed: Feb. 29, 2008

(51) Int. Cl. B60H 1/00

(52) U.S. Cl. 237/12.3 A; 237/2 A

(57) ABSTRACT

A heating system includes a heater installed in between the exhaust pipe and exhaust purifier of a diesel engine to heat the exhaust purifier in burning out cumulative carbon, a backpressure sensor for detecting the backpressure in the heater, a temperature sensor for detecting the temperature in the exhaust purifier, a fuel system for supplying a fuel mixture to the heater, an air compressor controllable to compress air into the fuel system to mix with a condensed fuel gas in the fuel system into a fuel mixture for delivery to the heater, and a computer controller electrically connected with the backpressure sensor and the temperature sensor for controlling the operation of the air compressor subject to the backpressure level detected by the backpressure sensor and the temperature detected by the temperature sensor.

### BACKGROUND OF THE INVENTION

(a) Technical Field of the Invention

The present invention relates to heating systems and more particularly, to a heating system for diesel engine that heats the exhaust purifier of the exhaust pipe by means of the catalyzing effect of a precious metal catalyzer to burn out cumulative carbon, maintaining optimal functioning of the exhaust purifier and normal exhaust function of the diesel engine.

(b) Description of the Prior Art

Diesel engine discharges a big amount of exhaust gas to pollute the atmosphere during operation. Due to trace amounts of H₂O and CO₂, the earth has a natural greenhouse effect. The enhanced greenhouse effect refers to natural gases by human activities. In late 20^{th}-century, the problem of greenhouse effect becomes a subject of great concern to people of vision. More particularly, experts in car industry continuously propose different measures, trying to reduce exhaust pollutants. One of the most outstanding and effective ways is to attach an exhaust purifier to the rear side of the exhaust pipe to effectively purify the exhaust gas of a diesel engine. However, an exhaust purifier for this purpose cannot eliminate cumulative carbon after a long of use, and cumulative carbon in the exhaust purifier affects the filtration performance of the exhaust purifier and the normal functioning of the diesel engine.

Backpressure sensor means may be installed in the exhaust system of a diesel engine to detect the backpressure in the exhaust purifier that is indicative of the status of accumulation of carbon. When the backpressure surpassed a predetermined level, the engine control system immediately produces a signal to increase the working temperature of the engine, thereby burning the cumulative carbon in the exhaust purifier. However, due to traveling environment or some other reasons, a car may frequently run at idle speed in a metropolitan city. Under this circumstance, it is difficult to increase the working temperature of the engine for burning the cumulative carbon in the exhaust purifier, and the exhaust gas purification performance of the exhaust purifier and the performance of the engine may be disturbed. In this case, the driver or owner of the car can only send the car to the car service center, requesting the mechanic to clean the exhaust purifier, resulting in a waste of time and money.

### SUMMARY OF THE INVENTION

The primary purpose of the present invention is to provide a heating system for diesel engine, which automatically heats the rear exhaust purifier of the exhaust pipe of the diesel engine to burn out cumulative carbon, maintaining optimal functioning of the exhaust purifier and normal exhaust function of the diesel engine.

It is another object of the present invention to provide a heating system for diesel engine, which utilizes the thermal energy of the exhaust gas to burn the supplied fuel mixture in burning out cumulative carbon.

It is still another object of the present invention to provide a heating system for diesel engine, which utilizes a precious metal catalyzer to catalyze the supplied fuel mixture, causing the fuel mixture to be burned by thermal energy of the exhaust gas.

To achieve these and other objects of the present invention, the heating system comprises a heater installed in between an exhaust pipe and an exhaust purifier of a diesel engine and adapted to heat the exhaust purifier in burning out cumulative carbon at the exhaust purifier; a backpressure sensor adapted to detect the backpressure in the heater; a temperature sensor adapted to detect the temperature in the exhaust purifier; a fuel system adapted to supply a fuel mixture to the heater; an air compressor controllable to compress air into the fuel system to mix with a fuel gas in the fuel system into a fuel mixture for delivery to the heater; and a computer controller electrically connected with the backpressure sensor and the temperature sensor and adapted to control the operation of the air compressor subject to the backpressure level detected by the backpressure sensor and the temperature detected by the temperature sensor.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic exploded view of a heating system for motor vehicle according to the present invention.

FIG. 2 is an assembly view of heating system for motor vehicle according to the present invention.

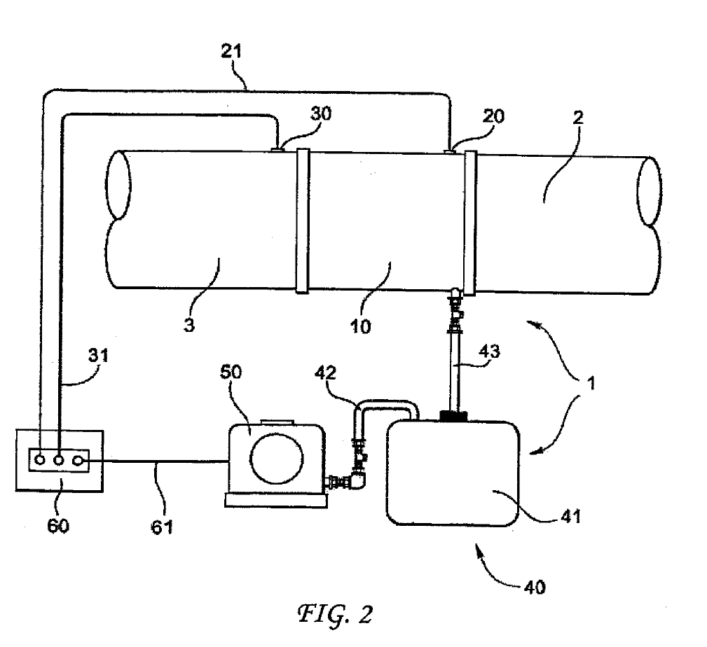

FIG. 3 is a schematic sectional view of the heating system for motor vehicle according to the present invention.

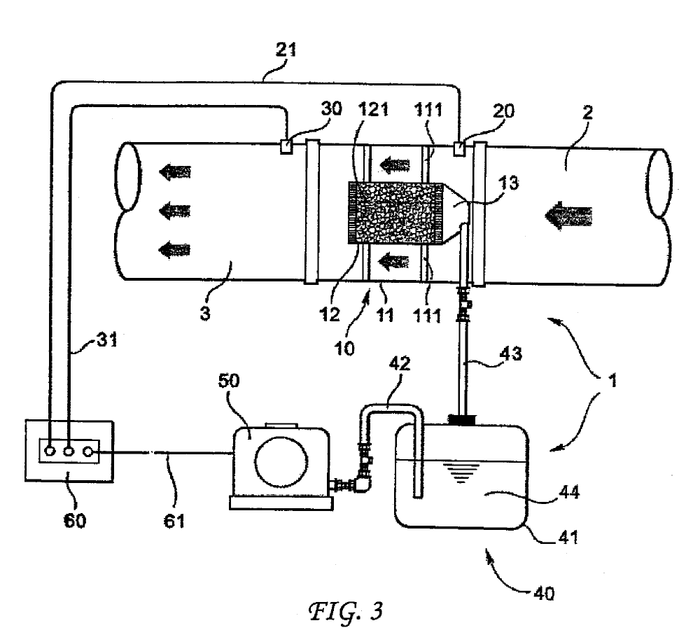

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

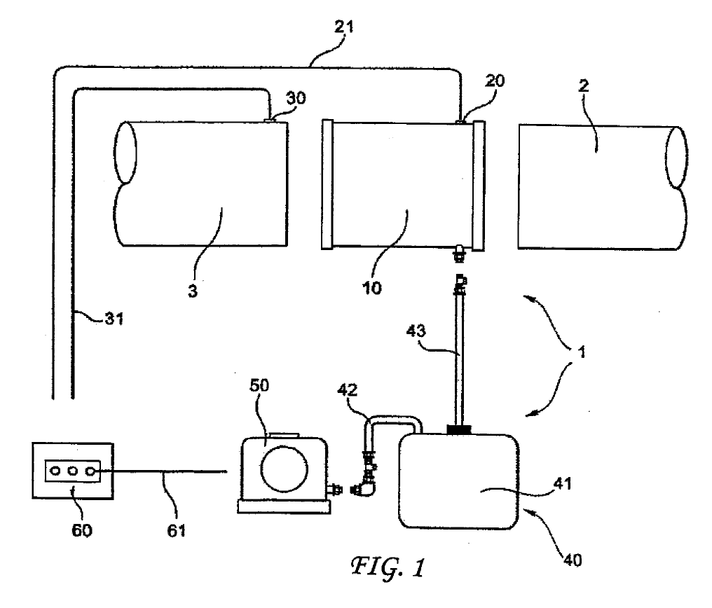

Referring to FIGS. 1˜3, a heating system 1 for motor vehicle in accordance with the present invention is shown comprised of a heater 10, a backpressure sensor 20, a temperature sensor 30, a fuel system 40, an air compressor 50, and a computer controller 60. The heater 10 comprises an outer tube 11, a heating tube 12, and a fuel nozzle 13. The heating tube 12 contains precious metal catalyzer grains 121. The precious metal catalyzer grains 121 are heat resisting ceramic grains coated with platinum (Pt), palladium (Pd), Rhodium (Rh), or Ruthenium (Ru). The fuel nozzle 13 is attached to the front side of the heating tube 12. The outer tube 11 has brackets 111 that hold the heating tube 12 fixedly inside the outer tube 11. The outer tube 11 has its front end connected to the rear end of an exhaust pipe 2 of a diesel engine (not shown). The backpressure sensor 20 is installed in the heating tube 12 near the front end of the heating tube 12, having a signal feedback line 21 electrically connected to the computer controller 60. The temperature sensor 30 is installed in a front end of an exhaust purifier 3 that is connected to the rear end of the heating tube 12. The temperature sensor 30 has a signal feedback line 31 electrically connected to the computer controller 60. The fuel system 40 comprises a fuel tank 41, an air intake pipe 42, an air/fuel mixing tube 43, and a proper amount of methyl alcohol 44. The air intake pipe 42 has one end connected to the fuel tank 41 and the other end connected to the air compressor 50. The air/fuel mixing tube 43 has one end connected to the fuel tank 41 and the other end connected to the fuel nozzle 13 of the heater 10. The computer controller 60 has a signal line 61 connected to the air compressor 50.

During operation of the diesel engine, exhaust gas is being discharged out of the exhaust pipe 2 through the gap between the outer tube 11 and heating tube 12 of the heater 10 into the exhaust purifier 3 and then purified by the exhaust purifier 3, and the gas that is exhausted out of the exhaust purifier 3 is not toxic. When the amount of cumulative carbon in the exhaust purifier 3 surpassed a predetermined level, the backpressure sensor 20 will be induced to output a backpressure signal to the computer controller 60 through the signal feedback line 21. Upon receipt of the signal, the computer controller 60 immediately drives the air compressor 50 to pump air through the air intake pipe 42 into the fuel tank 41 to mix with methyl alcohol 44 in the fuel tank 41, and the fuel mixture thus produced is delivered to the fuel nozzle 13 of the heater 10 and sprayed out of the fuel nozzle 13 toward the heating tube 12 in the form of a mist. At this time, the heating tube 12 has been heated to about 200° C. by the hot exhaust gas from the exhaust pipe 2, and the mist of fuel mixture of air and methyl alcohol 44 sprayed onto the inside of the heating tube 12 is catalyzed and cracked by the precious metal catalyzer grains 121 to produce a thermal energy over 400° C. that is discharged out of the heating tube 12. The exhaust gas that is discharged out of the exhaust pipe 2 through the gap between the outer tube 11 and the heating tube 12 and the gas of the thermal energy treated through the heating tube 12 are forced into the exhaust purifier 3, causing cumulative carbon on the surface of the filter core of the exhaust purifier 3 to be burned out.

During exhaust gas purification operation of the exhaust purifier 3, the temperature sensor 30 monitors the temperature in the exhaust purifier 3. If the temperature in the exhaust purifier 3 surpasses a predetermined value, for example, 450° C., the temperature sensor 30 immediately sends a signal through the signal feedback line 31 to the computer controller 60, causing the computer controller 60 to stop the air compressor 50 or to regulate the operating speed of the air compressor 50, stopping or reducing the supply of air to the fuel tank 41, and therefore the supply of fuel mixture to the heater 12 is stopped or reduced. In consequence, the temperature in the exhaust purifier 3 is lowered. Therefore, the heating system maintains the temperature in the exhaust purifier 3 within 450° C.

During operation of the heating system 1 to burn out cumulative carbon, the backpressure sensor 20 monitors the backpressure in the heater that is indicative of accumulation carbon. When the backpressure is below a predetermined value, the backpressure sensor 20 immediately gives a signal to the computer controller 60 through the signal feedback line 21, causing the computer controller 60 to turn off the air compressor 50.

The above procedure is repeated again and again to maintain optimal functioning of the exhaust purifier and normal exhaust function of the diesel engine.

Although a particular embodiment of the invention has been described in detail for purposes of illustration, various modifications and enhancements may be made without departing from the spirit and scope of the invention. For example, equivalent component parts may be used to substitute for the outer tube, heating tube and fuel nozzle of the heater, and isopropanol n-llexane, or any of a variety of other alcohol compounds or low-sulfur hydrocarbon compound may be used to substitute for methyl alcohol. Accordingly, the invention is not to be limited except as by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A heating system comprising:
a heater installed in between an exhaust pipe and an exhaust purifier of an engine and adapted to heat said exhaust purifier in burning out cumulative carbon at said exhaust purifier;
a backpressure sensor adapted to detect the backpressure in said heater;
a temperature sensor adapted to detect the temperature in said exhaust purifier;
a fuel system adapted to supply a fuel mixture to said heater;
an air compressor controllable to compress air into said fuel system to mix with a fuel gas in said fuel system into a fuel mixture for delivery to said heater; and
a computer controller electrically connected with said backpressure sensor and said temperature sensor and adapted to control the operation of said air compressor subject to the backpressure level detected by said backpressure sensor and the temperature detected by said temperature sensor.

2. The heating system as claimed in claim 1, wherein said heater comprises an outer tube connected in series between said exhaust pipe and said exhaust purifier, a heating tube concentrically suspending in said outer tube, said heating tube contains precious metal catalyzer grains, said precious metal catalyzer grains being heat resisting ceramic grains coated with one of the precious metals of platinum (Pt), palladium (Pd), Rhodium (Rh) and Ruthenium (Ru), and a fuel nozzle connected to said fuel system and adapted to spray a mist of said fuel mixture into said heating tube.

3. The heating system as claimed in claim 1, wherein said backpressure sensor is installed in a front side of said heat adjacent to said exhaust pipe, having a signal feedback line electrically connected to said computer controller.

4. The heating system as claimed in claim 1, wherein said temperature sensor is installed in a front side of said exhaust purifier adjacent to said heater, having a signal feedback line electrically connected to said computer controller.

5. The heating system as claimed in claim 1, wherein said fuel system comprises a fuel tank containing a condensed fuel gas, an air intake pipe, said air intake pipe having one end connected to said fuel tank and an opposite end connected to said air compressor for guiding a compressed air from said air compressor into said fuel tank to mix with said condensed fuel gas into said fuel mixture, an air/fuel mixing tube, said air/fuel mixing tube having one end connected to said fuel tank and an opposite end connected to said fuel nozzle to guide said fuel mixture out of said fuel tank to said fuel nozzle.

6. The heating system as claimed in claim 1, wherein said computer controller has a signal line connected to said air compressor.
